(19) United States
(12) Patent Application Publication
(10) Pub. No.: US 2025/0132403 A1
(43) Pub. Date: Apr. 24, 2025

(54) Method for Operating an Electrical Circuit Device, and Electrical Circuit Device

(71) Applicant: Bayerische Motoren Werke Aktiengesellschaft, Muenchen (DE)

(72) Inventor: Markus WOERNER, Eichstaett (DE)

(21) Appl. No.: 18/691,927

(22) PCT Filed: Sep. 19, 2022
(86) PCT No.: PCT/EP2022/075940

§ 371 Date: Mar. 14, 2024

(30) Foreign Application Priority Data
Sep. 20, 2021 (DE) 10 2021 124 232.0

(51) Int. Cl. H01M 10/42; H01M 10/615; H01M 10/625; H01M 10/653; H01M 10/6571

(52) U.S. Cl. CPC H01M 10/425; H01M 10/615; H01M 10/625; H01M 10/653; H01M 10/6571

(57) ABSTRACT

A method for operating an electrical circuit device includes the method step of opening a first switch and closing a second switch in order, in the case of a charging current or in the case of a discharging current of an electrical secondary storage unit, to generate Joule heat by way of current flow in the forward direction of a first diode, and/or including the method step of closing the first switch and opening the second switch in order to generate Joule heat in the case of current flow of the respective other current in the forward direction of a second diode.

### BACKGROUND AND SUMMARY

The invention relates to an electrical circuit device and to a method for operating the electrical circuit device, wherein the electrical circuit device comprises: a secondary electrical storage unit, a first electrical line for establishing electrical contact at a first polarity of the secondary electrical storage unit, a second electrical line for establishing electrical contact at a second polarity of the secondary electrical storage unit, a first conductor component having a first switch and a first diode connected in parallel with the first switch, and a second conductor component having a second switch and a second diode connected in parallel with the second switch. In this case, both the first semiconductor component and the second semiconductor component are integrated into the first electrical line or into the second electrical line or the first semiconductor component is integrated into the first electrical line or into the second electrical line and the second semiconductor component is integrated into the respective other electrical line, such that, when the first switch is open and the second switch is open in the case of a charging current of the secondary electrical storage unit, either the first diode or the second diode blocks the charging current and in the case of a discharge current of the secondary electrical storage unit the other of the two diodes blocks the discharge current.

From the prior art, for example, a back-to-back circuit of two semiconductor components as an isolating element for an accumulator battery implements a circuit device of this kind. A circuit device of this kind has the characteristic that, as in the case of a relay isolating switch, it is possible to block the charging current direction and discharge current direction, but, in contrast to a relay isolating switch, it is also possible to block the charging current direction of the secondary storage unit without blocking the discharge current direction and vice versa. A secondary storage unit is understood to mean an accumulator battery, that is to say a storage unit that can be discharged and charged. The semiconductor components also enable shorter switching times than a relay isolating switch and can be switched at higher currents than a relay isolating switch. In normal operation according to the prior art, both switches are closed such that both current directions (charging and discharging) are not blocked. If one of these current directions should be blocked, which does not constitute regular operation according to the prior art but represents a protective scenario, the switch with a parallel-connected diode blocking the desired current direction is opened.

It is an object of the invention to provide an improved method for operating an electrical circuit device of this kind and to improve the electrical circuit device.

This object is achieved by a method and by an electrical circuit device according to the independent claims. Advantageous embodiments and developments of the invention are found in the dependent claims.

In the method according to the invention, the first switch is opened and the second switch is closed in order, in the case of a charging current or in the case of a discharge current, to generate Joule heat by way of current flow in the forward direction of the first diode and, as an alternative or in addition, the first switch is closed and the second switch is opened in order to generate Joule heat in the case of current flow of the respective other current in the forward direction of the second diode.

This method can be implemented in the context of normal operation of the electrical circuit device in order to specifically generate Joule heat by way of the diodes or one of the diodes. The heat can be used to heat the secondary electrical storage unit, for example. This is advantageous, for example, in certain types of lithium-ion storage units, which are used as secondary electrical storage units, at low temperatures in order to increase the temperature of the storage unit and thus the reactivity thereof. The method is aimed at switching the switches of the semiconductor components such that the charging and/or discharge current of the storage unit results in “inherent heating” thereof, where these currents are directed specifically in the forward direction through the diodes which generate Joule heat.

According to one development of the method, the two method steps are repeated in a predeterminable period of time in such a way as to generate Joule heat constantly in the predeterminable period of time both in the case of a charging current of the secondary electrical storage unit and in the case of a discharge current of the secondary electrical storage unit.

The generation of heat by the diodes in the predeterminable period of time is optimized in this way by virtue of the discharge current not being blocked when there is a change, for example, from charging to discharging of the storage unit, but the discharge current is used for generating heat. When there is a change back to charging, this continues to apply, provided that the switches are closed and opened alternately.

The electrical circuit device according to the invention can be operated in normal operation according to one of the methods mentioned, wherein the electrical circuit device comprises a heat transfer medium between the first diode and the electrical energy storage unit and/or between the second diode and the electrical energy storage unit in order to transfer Joule heat from the first diode and/or second diode to the electrical energy storage unit in a manner which minimizes heat losses.

The device thus comprises an item which enables more effective heat transfer than if this item were not provided.

This item may be, for example, a thermally conductive paste, a thermally conductive plate, or a combination of both, with each of these media transferring heat better than, for example, air.

According to another embodiment, the first semiconductor component and the second semiconductor component are both embodied in each case as a MOSFET (metal-oxide-semiconductor field-effect transistor) or an IGBT (insulated-gate bipolar transistor) or a SiC transistor (silicon carbide transistor).

In particular, the electrical circuit device can be integrated into an on-board power supply system of a vehicle and can be operated according to the method according to the invention.

The invention is based on the considerations presented below. Batteries made from cells with lithium-ion technology (Li batteries) have a lower performance at cold temperatures. This is due to the reactivity of the chemical compounds involved in the chemical reactions, which is reduced at low temperatures.

In vehicles with an Li battery integrated into the on-board power supply system thereof, this underperformance could lead to functional restrictions of the vehicle. It is therefore desirable to bring the Li battery to higher-performance temperature ranges as quickly as possible. To this end, in the prior art, for example heating elements are installed in the Li battery or the Li battery is conditioned by means of external heat sources, where reference can be made, for example, to the document DE 10 2011 104 000 A1.

An advantageous alternative is proposed here for the operation of a Li battery with currents (charging current and discharge current) that can each be blocked using a semiconductor component (in protective operation), as prescribed, for instance, in the standard UN38.3.

When a Li battery having a semiconductor isolating element consisting of two switchable semiconductor components (for example in a back-to-back embodiment) is in operation, in each case only one switch can be actuated. As a result, the current is carried via the so-called body diode of the non-actuated semiconductor and heats it up. This power loss, which arises in the diode as heat, can be used to heat up the Li battery without separate heating elements being provided. The effect of the battery heating process can be optimized further with the integration of heat transfer media.

The following text describes a preferred exemplary embodiment of the invention based on the appended drawings. Further details, preferred embodiments and developments of the invention result therefrom.

### BRIEF DESCRIPTION OF THE DRAWINGS

FIG. 1 schematically shows an exemplary schematic section of an electrical circuit in an on-board electrical power supply system of a vehicle;

FIG. 2 schematically shows an alternative exemplary schematic section of an electrical circuit in an on-board electrical power supply system of a vehicle;

FIG. 3 schematically shows a switch position in order to generate heat during charging; and

FIG. 4 schematically shows a switch position in order to generate heat during discharging.

### DETAILED DESCRIPTION OF THE DRAWINGS

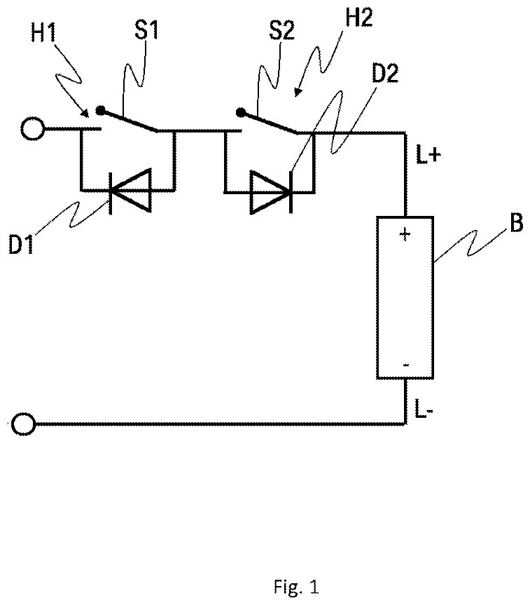

FIG. 1 shows a secondary electrical storage unit with lithium-ion technology B, the polarities positive+and negative−of which are contact-connected via the lines L+ and L−, wherein a circuit composed of two semiconductor components H1 and H2 in series is located in the line L+. Both components consist of a switch S1, S2, wherein a respective diode D1, D2 is connected in parallel with the switch. The diodes may be intrinsic diodes of the semiconductor components and are also referred to as body diodes. The diodes D1 and D2 are connected in opposition.

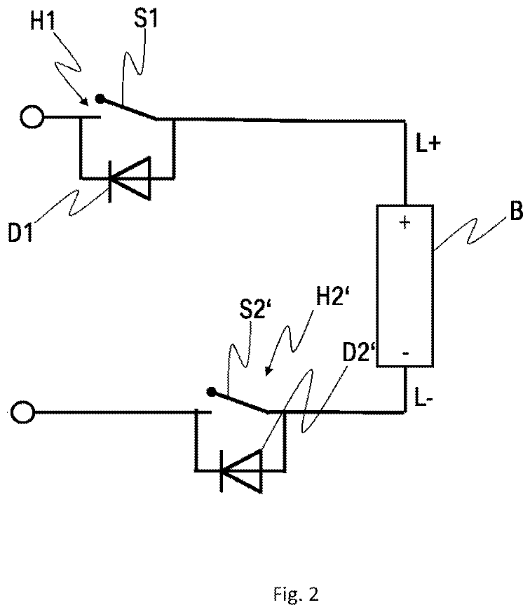

FIG. 2 differs only insofar as the second semiconductor component H2′, having the switch S2′ and the diode D2′ in parallel therewith, is integrated into the line path L−.

Modified embodiments are also considered for the circuit configurations according to FIGS. 1 and 2, where each of the diodes D1 and D2, D2′ is integrated in the respective reverse direction or polarity (not shown). The semiconductor components H1 and H2, H2′ can also each be connected in parallel with the semiconductor components H1 and H2, H2′ of other similar semiconductor components, such that a respective group of semiconductor components H1_{grouped} and H2_{grouped}, H2′_{grouped} is formed (not shown). All switches of the semiconductor components forming the group are then switched simultaneously, which applies to normal operation according to the prior art, for protective operation according to the prior art and for normal operation according to the invention.

In normal operation according to the prior art of circuit configurations according to FIG. 1 or 2 and the described possible modifications, the switch S1 and the switch S2, S2′ are closed in order to be able to charge and discharge the storage unit B. In protective operation, the switch S1 is closed and the switch S2, S2′ is opened in order to enable charging of the storage unit B but to block a discharge current across the diode D2, D2′, that is to say a connected load is not supplied with electrical power by the storage unit B. It is also possible to open the switch S1 and to close the switch S2, S2′ in order to enable discharging of the storage unit B but to block a charging current across the diode D1, that is to say the storage unit B is not charged when a charging voltage is applied.

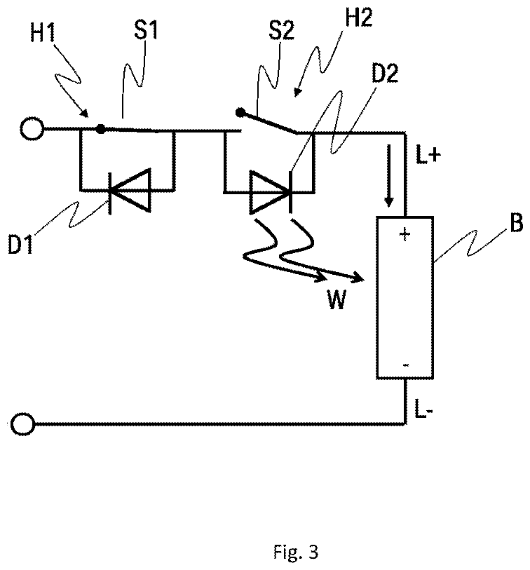

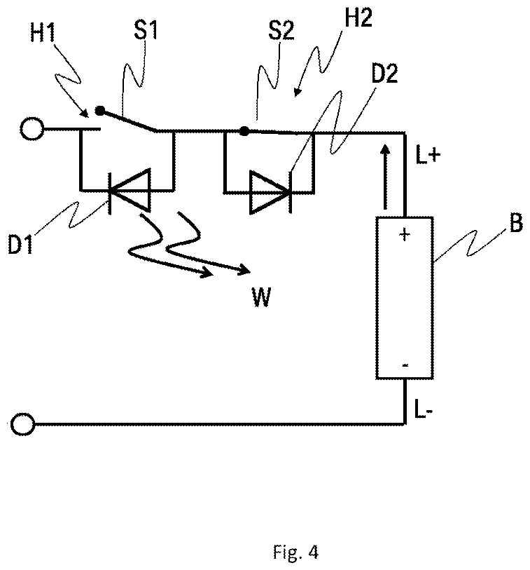

According to FIG. 3, in normal operation according to the invention, when the storage unit B is charged (charging current in the direction of the arrow), the switch S1 is closed and the switch S2, S2′ is opened not in order to block a discharge current but rather in order to generate heat W by means of the charging by way of current flow across the diode D2. Because the discharge current is not intended to be blocked currently, the switch S2, S2′ is closed and the switch S1 is opened during discharging in order to enable the discharging and to generate heat W by means of the discharging by way of current flow across the diode D1 (see FIG. 4, discharge current in the direction of the arrow). Therefore, in normal operation, neither of the two current flows are blocked but heat is generated with each of the two current flows.

For optimum heat transfer, a heat transfer medium, such as a heat transfer plate, for example, is provided between the diodes D1 and D2, D2′ and the storage unit B, the heat transfer plate distributing the heat W which arises in spots as extensively as possible across the entire storage unit B (not explicitly shown in the figures; effect is illustrated by the curved arrows in FIGS. 3 and 4).

1.-6. (canceled)

7. A method for operating an electrical circuit device, wherein the electrical circuit device comprises:
a secondary electrical storage unit;
a first electrical line for establishing electrical contact at a first polarity of the secondary electrical storage unit;
a second electrical line for establishing electrical contact at a second polarity of the secondary electrical storage unit;
a first semiconductor component having a first switch and having a first diode connected in parallel with the first switch;
a second semiconductor component having a second switch and having a second diode connected in parallel with the second switch,
wherein:
(i) both the first semiconductor component and the second semiconductor component are integrated into the first electrical line or into the second electrical line, or
(ii) the first semiconductor component is integrated into the first electrical line or into the second electrical line and the second semiconductor component is integrated into the respective other electrical line,
the method comprising the steps of:
when the first switch is open and the second switch is open in a case of a charging current of the secondary electrical storage unit, blocking the charging current with either the first diode or the second diode and, in a case of a discharge current of the secondary electrical storage unit, blocking the discharge current with the other of the two diodes;
opening the first switch and closing the second switch in order, in the case of a charging current or in the case of a discharge current, to generate Joule heat by way of current flow in a forward direction of the first diode, and/or
closing the first switch and opening the second switch in order to generate Joule heat in the case of current flow of the respective other current in the forward direction of the second diode.

8. The method according to claim 7, further comprising the step of:
(i) opening the first switch and closing the second switch in order, in the case of the charging current or in the case of the discharge current, to generate Joule heat by way of current flow in the forward direction of the first diode; and
(ii) closing the first switch and opening the second switch in order to generate Joule heat in the case of current flow of the respective other current in the forward direction of the second diode,
wherein steps (i) and (ii) are repeated in a predeterminable period of time so as to generate Joule heat constantly in the predeterminable period of time both in the case of a charging current of the secondary electrical storage unit and in the case of a discharge current of the secondary electrical storage unit.

9. An electrical circuit device, comprising:
a secondary electrical storage unit;
a first electrical line for establishing electrical contact at a first polarity of the secondary electrical storage unit;
a second electrical line for establishing electrical contact at a second polarity of the secondary electrical storage unit;
a first semiconductor component having a first switch and having a first diode connected in parallel with the first switch;
a second semiconductor component having a second switch and having a second diode connected in parallel with the second switch;
wherein:
(i) both the first semiconductor component and the second semiconductor component are integrated into the first electrical line or into the second electrical line, or
(ii) the first semiconductor component is integrated into the first electrical line or into the second electrical line and the second semiconductor component is integrated into the respective other electrical line,
wherein, when the first switch is open and the second switch is open in the case of a charging current of the secondary electrical storage unit, either the first diode or the second diode blocks the charging current and in the case of a discharge current of the secondary electrical storage unit the other of first or second diodes blocks the discharge current; and
a heat transfer medium between the first diode and the electrical energy storage unit and/or between the second diode and the electrical energy storage unit in order to transfer Joule heat from the first diode and/or second diode to the electrical energy storage unit in a manner which minimizes heat losses.

10. The electrical circuit device according to claim 9, wherein
the heat transfer medium comprises a thermally conductive paste and/or a thermally conductive plate.

11. The electrical circuit device according to claim 9, wherein
the first semiconductor component and the second semiconductor component are both embodied in each case as a MOSFET, an IGBT, or a SiC transistor.

12. A vehicle onboard power supply system comprising an electrical circuit device according to claim 9.
